(19) United States
(12) Patent Application Publication
(10) Pub. No.: US 2019/0123630 A1
(43) Pub. Date: Apr. 25, 2019

(54) CONTINUOUSLY VARIABLE MAGNETIC REDUCTION DRIVE AND CLUTCH

(71) Applicant: Raymond James Walsh, Island Park, ID (US)

(72) Inventor: Raymond James Walsh, Island Park, ID (US)

(21) Appl. No.: 16/215,585

(22) Filed: Dec. 10, 2018

Related U.S. Application Data
(63) Continuation-in-part of application No. 15/878,236, filed on Jan. 23, 2018.
Application No. 15/878,236 is a continuation-in-part of application No. 14/523,687, filed on Oct. 24, 2014, now Pat. No. 10,125,814.
Application No. 15/878,236 is a continuation-in-part of application No. 14/185,910, filed on Feb. 20, 2014, now Pat. No. 9,876,407.
(60) Provisional application No. 62/596,376, filed on Dec. 8, 2017.
(60) Provisional application No. 62/596,376, filed on Dec. 8, 2017.
(60) Provisional application No. 61/895,115, filed on Oct. 24, 2013.
(60) Provisional application No. 61/906,703, filed on Nov. 20, 2013.
(60) Provisional application No. 61/906,136, filed on Nov. 19, 2013.
(60) Provisional application No. 61/899,204, filed on Nov. 2, 2013.
(60) Provisional application No. 61/895,115, filed on Oct. 24, 2013.
(60) Provisional application No. 61/894,489, filed on Oct. 23, 2013.
(60) Provisional application No. 61/892,019, filed on Oct. 17, 2013.
(60) Provisional application No. 61/891,829, filed on Oct. 16, 2013.
(60) Provisional application No. 61/766,705, filed on Feb. 20, 2013.

(51) Int. Cl. H02K 49/10

(52) U.S. Cl. CPC H02K 49/108; F16D 27/01

(57) ABSTRACT

A variable magnetic torque transfer device includes at least one magnetic rotor and an induction cylinder that is in close proximity to the magnetic rotor. The magnetic rotor has a number of individual magnets positioned on it in alternating in magnetic orientation. In operation, the induction cylinder is placed adjacent the magnetic rotor for relative rotation through magnetic flux lines emanating from the magnetic rotor. Some versions include two magnetic rotors and the induction cylinder is advantageously disposed between the two rotors. A method of torque transfer includes placing the induction cylinder adjacent to the magnetic rotor, or between two magnetic rotors, to cause the induction cylinder to pass through magnetic flux lines emanating from the magnetic rotor or rotors.

### CROSS-REFERENCE TO RELATED APPLICATIONS

This application claims benefit of U.S. provisional patent application No. 62/596,376, filed Dec. 8, 2017, and is a continuation-in-part of co-pending U.S. non-provisional patent application Ser. No. 15/878,236, filed Jan. 23, 2018, which claims benefit of U.S. provisional patent application No. 62/596,376, filed Dec. 8, 2017, is a continuation-in-part of U.S. non-provisional patent application Ser. No. 14/523,687, filed Oct. 24, 2014, which issued as U.S. Pat. No. 10,125,814 on Nov. 13, 2018, and which claims benefit of U.S. provisional patent application No. 61/895,115, filed Oct. 24, 2013, and is a continuation-in-part of U.S. non-provisional patent application Ser. No. 14/185,910, filed Feb. 20, 2013, which issued as U.S. Pat. No. 9,876,407, on Jan. 23, 2018, and which claims benefit of: U.S. provisional patent application No. 61/906,703, filed Nov. 20, 2013; U.S. provisional patent application No. 61/906,136, filed Nov. 19, 2013; U.S. provisional patent application No. 61/899,204, filed Nov. 2, 2013; U.S. 61/895,115, filed Oct. 24, 2013; U.S. provisional patent application No. 61/894,489, filed Oct. 23, 2013; U.S. provisional patent application No. 61/892,019, filed Oct. 17, 2013; U.S. provisional patent application No. 61/891,829, filed Oct. 16, 2013; and U.S. provisional patent application No. 61/766,705, filed Oct. 20, 2013, the disclosures of all of which are incorporated herein by reference in their entirety

### BACKGROUND

In a motor vehicle, a powertrain includes a series of mechanical components that generate rotational power or torque and deliver this power to a road surface, water, or air. The powertrain includes the engine with its driving shaft, a clutch to engage or disengage the driving shaft, and a transmission with its driven shaft. The final drive may be wheels or a propeller.

A transmission or reduction drive is a mechanic device that reduces the rotational speed of the engine to a lesser speed for the wheels or propeller. The result is a final drive shaft having higher torque per revolution than the engine. The most common example is an automobile transmission. Reduction drives are also used with propeller driven machines such as wind turbines, marine vessels, or airplanes in order to optimize the speed of a propeller.

Types of transmissions may include a gearbox, a torque-converting fluid coupling, or a continuously variable system. Simple transmissions have a fixed gear ratio that cannot be changed during use. A continuously variable transmission (CVT) employs a belt drive with expanding pulleys to allow the gear ratio to change during operation. Both simple transmissions and CVTs are mechanical devices that eventually fail due to friction and mechanical wear.

A transmission is typically coupled to a clutch, which is interposed between the engine and the transmission for the purpose of engaging or disengaging the driving shaft of the engine to the driven shaft of the transmission. A clutch functions as a mechanical on/off switch.

One type of clutch is a slip clutch. The slip clutch is capable of slipping or disengaging when torque is too great. When a clutch is fully engaged or locked, the driving shaft and the driven shaft rotate at the same speed. Slippage occurs when the driving shaft does not fully engage, with the result that the driven shaft rotates at a slower speed than the driving shaft. A brief period of slippage may be a good thing in that it allows for the smooth transition between engagement and disengagement. The friction clutch transmits torque between two flat plates with the degree of slippage determined by how forcefully the driving plate is pressed against the driven plate. In this case, slippage quickly generates undesirable heat, which over time can warp clutch surfaces and negatively affect torque transmission.

A magnetic coupling is a coupling that transfers torque from one machine member to another using a magnetic field rather than a physical or mechanical connection for torque transfer. Such a coupling is exemplified in the Halbach Motor and Generator, U.S. Pat. No. 9,876,407, which discloses a means and method of magnetic torque transfer.

Magnetic couplings are used in liquid pumps and propeller systems where a wall or barrier is placed between magnetically coupled machine members to separate a liquid or gas on one side of a pipe from a motor operating on the other side. Magnetic coupling obviates the use of shaft seals, which eventually lose their seal due to wear associated with the sliding of two surfaces against one another.

Permanent magnet motors generate torque through an attraction between a permanent magnet and an electromagnet. The power density of a motor depends on the magnitude of the electromotive forces between the permanent magnet and the electromagnet. The strength of the permanent magnet depends on the composition of the magnet, with neodymium-iron-boron magnets proving the strongest. The strength of the electromagnet increases with the square of the number of windings, and/or the square of the current passing through the coil. Where energy is abundant, permanent magnet motors are designed to accommodate a large current. However, where electric power is less plentiful, such as in battery-powered applications, permanent magnet motors that have electromagnets wound with smaller gauge wire allow for a greater number or density of windings, which generates the most efficient ratio of electromotive force for a given power input. Designs incorporating permanent magnets that are large relative to the coils further enhance energy efficiency.

### SUMMARY OF THE DISCLOSURE

Embodiments of the invention include a continuously variable magnetic reduction drive, or CVMRD, in which torque is variably transferred between a circular or cylindrical permanent magnet assembly, hereafter the magnet assembly, and an induction cylinder made of electrically conductive material such as copper, in accordance with Lenz's Law of Induction. This drive allows for contactless and continuous matching of the torque needs of a system with torque available across a broad range of torque requirements. The magnet assembly is preferably positioned near the induction cylinder so that rotation of the magnet assembly relative to the induction cylinder causes the conductor within the induction cylinder to experience a moving magnetic field. A conductor and a magnetic field that moves relative to the conductor set the precondition for Lenz's Law.

With this in mind, the function of the magnet assembly is to direct magnetic flux towards the induction cylinder. Torque transfer may be achieved by a single or dual rotor magnet assembly having any number of individual magnets positioned outside or inside the induction cylinder rotating relative to the induction cylinder. Adjacent magnets on the magnet assembly may alternate in magnetic polarity from north to south. Many embodiments are possible, one example being a single Halbach cylinder positioned outside the induction cylinder and configured to direct magnetic flux inward toward the induction cylinder. A second example places the Halbach cylinder inside the induction cylinder so that flux is directed outward from the Halbach cylinder toward the induction cylinder.

When an embodiment has both an inner and an outer cylinder magnetically coupled across a gap, a second method of torque transfer by magnetic induction becomes possible. When the cylinders are rotated, an induction cylinder interposed between the cylinders will experience a rotating magnetic field, creating torque according to Lenz's Law. The magnetic coupling between cylinders occurs at discrete nodes of increased magnetic flux within the gap between the cylinders. These nodes alternate N/S in magnetic polarity.

The flux within the gap of the dual rotor design does not decrease with the inverse square of the distance, as with the single rotor design, but remains more consistent across the gap. Therefore a dual-rotor design allows for greater gap size without significant loss of torque transfer. The single-rotor design is much simpler, however. Neither design is generally preferred over the other; rather some applications may favor a single-rotor design while others favor the dual-rotor approach.

In both single- and dual-rotor designs, movement of magnetic fields in proximity to the induction cylinder will induce a circular electric current wholly contained within the induction cylinder as per Lenz's Law. This induced current will give rise to a magnetic field of its own emanating from the induction cylinder. The induced magnetic fields of the induction cylinder attract the permanent magnetic fields of the magnet assembly, and this causes the induction cylinder to move in similar fashion to the magnet assembly.

Importantly, the reverse is also true. Rotating the induction cylinder in proximity to the magnet assembly will induce the magnet assembly to move in similar fashion as the induction cylinder.

The degree to which torque is transferred between the magnet assembly and the induction cylinder depends on several factors. These factors include the relative rotational rate, the strength of the magnetic fields, the conductivity of the induction cylinder, and the mass or thickness of the conductor. A thicker-walled induction cylinder will affect greater torque transfer than a thin-walled cylinder. Copper is an excellent conductor and will affect high torque transfer. Titanium, a poor conductor, will affect a lesser torque transfer. For cost considerations, aluminum might be sufficient, or perhaps an alloy of copper.

The degree of torque transfer also depends on the extent of the overlap between the induction cylinder and the cylindrical magnet assembly. The CVMRD allows the user to control the rate of torque transfer by controlling the degree to which the induction cylinder enters into the magnetic fields produced by the single or dual rotor magnet assembly. The greater the depth of insertion the more the magnet assembly bathes the conductor in magnetic flux, and the more torque is transferred.

The induction cylinder may have a graduated thickness in order to modulate and optimize the torque transfer curve. One end of the cylinder may be thinner relative to the other end. The variations in cylinder thickness may be continuous or stepped, or both. Cooling fins attached to the induction cylinder will mitigate the accumulation of heat.

The continuously variable magnetic reduction drive facilitates the transfer of kinetic energy or mechanical torque. Torque input may be from any number of sources, such as an internal combustion motor, an electric motor, wind, or running water. After passing through the reduction drive, torque may be output to a variety of devices, including wind or water propellers, wheels, or an electric generator. The types of torque input and the objective of torque output are too numerous to list here.

There are also a variety of means of mechanical torque delivery or output. These means include a driving shaft between the motor and transmission of a car, and the driven shaft between the transmission and the wheels. Some large ships use a worm gear to receive mechanical torque from a motor and deliver it to a propeller or screw. A pulley wheel with a belt, or a sprocket with a chain are also means of passing torque from one machine element to another. Any of these means, and many others, may be used to deliver mechanical torque to and from the continuously variable magnetic reduction drive.

The CVMRD serves as a mechanical clutch, allowing for the smooth, contactless, transmission of mechanical power between the induction cylinder and the magnet assembly. The induction cylinder may be attached to the driving shaft while the magnet assembly is attached to the driven shaft. The converse is also possible, with the induction cylinder attached to the driven shaft while the induction cylinder is attached to the driving shaft.

In either embodiment, there can never be 100% torque transfer in a magnetic induction system because there must be relative movement between the inductor and the magnetic field. At sufficiently high rotational rates the torque transfer approaches 100%. Another way to describe the phenomenon is to state that there will always be slippage in the torque transfer between magnetically coupled cylinders and induction cylinder. Varying the depth of insertion also varies the degree of slippage, with greater depth of insertion resulting in lesser slippage. Slippage is also at a minimum when the rotational rates are highest. Unlike mechanical slippage between clutch plates, magnetic induction slippage does not generate friction so a mechanical clutch will not wear out or need replacement.

In one embodiment, the induction cylinder is attached operationally to a shaft having a propeller and a variable passive magnetic bearing. An example of this type of bearing is disclosed in U.S. Pat. No. 10,125,814, which may be thought of as a variable magnetic thrust plate. Many other types of magnetic bearing may also be used, including any type of electromagnetic bearing.

A typical mechanical roller-bearing thrust plate allows for limited or no axial or longitudinal displacement, but does allow for rotational movement about the axis. In contrast, a passive magnetic bearing permits a limited axial or longitudinal displacement of the shaft in response to an axial load, such that the greater the load the greater the axial displacement up to the point of failure of the magnetic bearing. Within the operating range, however, an increasing axial force causes an increase in axial displacement of the shaft up to a point where there is an equal and opposite force on the shaft imparted by the magnetic bearing. Free and unrestricted rotation about the longitudinal axis is permitted throughout the operating range of the passive magnetic bearing. Thus, any sort of variable axial displacement magnetic thrust bearing may be employed so long as the bearing allows free axial rotation.

A variable axial displacement magnetic bearing may be combined with the continuously variable magnetic reduction drive in a propeller-driven machine in order to supply adequate torque during acceleration and optimal energy efficiency at cruising speed. Any sort of motor may be employed, including electric motors, internal combustion motor, and turbojet motors, for example.

One embodiment includes a propeller-driven craft having both a CVMRD and a variable passive magnetic bearing configured within the drivetrain. At low motor speeds, propeller rotation produces relatively low thrust resulting in a smaller axial displacement of the propeller shaft. Such a small shaft displacement results in partial insertion of the induction cylinder within the magnet assembly, and a commensurately small transfer of torque between the motor and the propeller. When increased thrust is required, an increase in motor speed results in increased propeller speed and thrust, which also increases the depth to which the induction cylinder enters the magnet assembly, thereby transferring greater torque from the motor drivetrain to the propeller shaft. This embodiment allows for continuous matching of the torque requirement of the propeller with the torque output of the engine. In aircraft applications, this embodiment obviates the need for a power take-off accessory drive.

The efficiency of torque transfer is further enhanced with the addition of a variable pitch assembly to the propeller, a device well-known to those skilled in the art. A variable pitch propeller changes blade pitch to generate optimal thrust. One might think increasing propeller speed increases thrust. This is true in a limited sense, however, increased propeller speed decreases thrust efficiency due to factors such as energy-robbing cavitation. Each degree of pitch will have a narrow range of propeller speeds within which optimal thrust is produced. Configured within a CVMRD, varying thrust also varies the degree of engagement of the induction cylinder penetration within the magnet assembly. The CVMRD ensures that the torque required by a given propeller pitch is matched to the torque produced by the motor. This is what is meant by torque matching.

Propeller-driven watercraft will frequently employ a reduction drive when the optimal rotational rate of the engine exceeds the optimal rotational rate of the propeller. A CVMRD plus variable passive magnetic bearing may be configured as above to reduce the rotational rate of a marine vessel motor operating at 1000 rpm's down to a propeller speed of, for example, 250 rpm's. The CVMRD has the added benefit of dampening propeller noise and vibration since the mechanical drive train is interrupted by the magnetic coupling between the induction cylinder and the magnet assembly. There is no direct mechanical connection between the motor and the propeller so there is no direct transfer of vibrations to the propeller. Vibrations are a source of propeller fatigue and failure over the course of time.

It may be advantageous to employ the CVMRD within a wind generator. A wind turbine propeller or blade will have a certain rotational speed that is optimal for torque transfer depending on the pitch of the propeller. The CVMRD coupled with a passive magnetic bearing may be employed to maintain optimal propeller speed across a range of wind speeds.

Wind flowing over a typical turbine propeller creates a linear force or pressure against the propeller. The propeller converts this linear force into rotational motion. The propeller shaft is typically attached to a thrust bearing, which prevents the shaft from shifting in a linear direction as the shaft rotates, so wind energy is converted only to propeller torque. Turbine blade pitch determines the optimal rotational rate for the most efficient transfer of torque. Wind speed above or below this optimal speed will result in suboptimal torque transfer. The CVMRD allows increased torque transfer with increasing wind speed without increasing propeller speed.

In this embodiment, a propeller driveshaft is attached to a variable passive magnetic bearing. When blowing wind creates a linear force against the propeller, some of the linear force turns the propeller while some of the force pushes or displaces the propeller shaft in an axial or longitudinal direction within a passive magnetic bearing. The propeller shaft is further attached to a CVMRD so that axial displacement pushes the induction cylinder deeper into the magnetic assembly, resulting in greater torque transfer. When a rotor of the magnet assembly is positioned within generator coils, electricity is produced. The harder the wind blows, the deeper the induction cylinder enters the generator, and the more electricity is produced. The generator resists shaft rotation, so increased torque generated by increased wind serves to generate more electricity rather than increasing the rotational rate of the propeller.

A compact embodiment of an electric powertrain positions the dual rotor CVMRD magnet assembly within a dual rotor electric toroid motor wherein at least one rotor is configured for rotation within a toroid-shaped stator. One example is disclosed in the Halbach Motor and Generator, U.S. Pat. No. 9,876,407. A second example is disclosed in copending U.S. patent application Ser. No. 15/878,236 filed Jan. 23, 2018. These two examples are not intended to limit the scope of the embodiment in any way, as other examples of toroid motors may exist now or at some point in the future.

In this compact embodiment, the dual magnet rotor serves double duty. A first magnetic rotor is positioned within the toroid stator or coil assembly for rotation within the stator. A secondary rotor is magnetically coupled to the first magnetic rotor, and positioned coaxially outside the stator coils such that there is a gap between the secondary rotor and the stator coils sufficient in size to receive a cylindrical induction cylinder. When energized, the stator urges the first magnetic rotor and the secondary rotor to rotate. This rotation creates a moving magnetic field. When the induction cylinder enters the gap, torque generated by the motor is transferred magnetically to the induction cylinder. In this way, the magnetically-coupled dual rotors serve to both generate electromotive force and to variably transfer torque. Thus, the reduction drive/transmission/clutch embodied within the CVMRD becomes a component of the electric motor for substantial space and weight savings.

Where greater torque is required, multiple compact embodiments may be positioned adjacent one another so as to share a common driveshaft. Even multiple motor/CVMRD devices attached to a common or shared drive train allows for torque matching, wherein the torque required by the wheels or propeller is seamlessly matched by the torque produced by the multiple motors.

In some applications, greater energy efficiency may be desirable. Efficiency may be stated simplistically as the ratio of kinetic energy of a moving vessel divided by the energy consumed by the powertrain of the moving vessel. Where efficiency is desired, an embodiment may have a dual-rotor CVMRD configured so that the rotors are also employed within a motor configured for rolling biphasic coil. Such an embodiment would have a high thrust to weight ratio, and would be capable of delivering high thrust for power take-off as well as delivering high efficiency power at cruising speed.

The CVMRD may operate as the primary means of torque transfer, or as a secondary means of torque transfer. As described previously, the CVMRD provides a contactless means of transferring torque in a variable fashion, and induction torque transfer may be the only method of torque transfer within a given machine. In another embodiment, the CVMRD may provide for supplemental torque transfer while the primary method of torque transfer is magnetic. Such a magnetic method of torque transfer is disclosed in the Halbach Motor and Generator, U.S. Pat. No. 9,876,407. If the CVMRD were employed within a vehicle motor, for example, the power train might be driven by magnetic torque transfer while the CVMRD is employed to operate secondary systems, such as an air conditioner compressor, for example.

### BRIEF DESCRIPTION OF THE DRAWINGS

FIG. 1 is a schematic diagram exemplifying a single rotor embodiment of a magnet assembly and an induction cylinder in accordance with principles of the present invention;

FIG. 2 is a schematic diagram exemplifying a dual rotor embodiment having coaxial-coupled magnet cylinders and an induction cylinder in accordance with principles of the present invention;

FIGS. 3A, 3B, 3C, AND 3D are cross-sections of the embodiment of FIG. 2, showing progressive penetration of the induction cylinder into the gap between magnet cylinders;

FIG. 4 is a graph of experimental data showing the portion of torque transferred in one exemplary embodiment of the present invention;

FIGS. 5A and 5B are frontal and side illustrations of an embodiment of the invention having multiple wheel bearings that center a magnet rotor between coils;

FIGS. 6A and 6B are sectional schematics of an embodiment of the invention having a magnet assembly and propeller in two states of engagement;

FIG. 7 is an exploded view of a compact embodiment of a magnetic reduction drive and toroid motor, according to embodiments of the invention; and

FIG. 8 is a cross-sectional illustration of the embodiment of FIG. 7.

### DETAILED DESCRIPTION OF THE INVENTION

Referring now to the drawings wherein depicted elements are, for the sake of clarity, not necessarily shown to scale and wherein like or similar elements are designated by the same reference numeral through the several views. In the interest of conciseness, well-known elements may be illustrated in schematic or block diagram form in order not to obscure the herein-described embodiments in unnecessary detail, and details concerning various other components known to the art, such as magnets, electromagnets, variable pitch propellers, actuators, and the like described with reference to the operation of many devices and have not been shown or discussed in detail inasmuch as such details are not considered necessary to obtain a complete understanding of the present invention, and are considered to be within the skills of persons of ordinary skill in the relevant art. It is also understood to those skilled in the art that a permanent magnet motor that converts electricity to kinetic energy may in certain instances also function in reverse to generate electricity with the controlled input of kinetic energy.

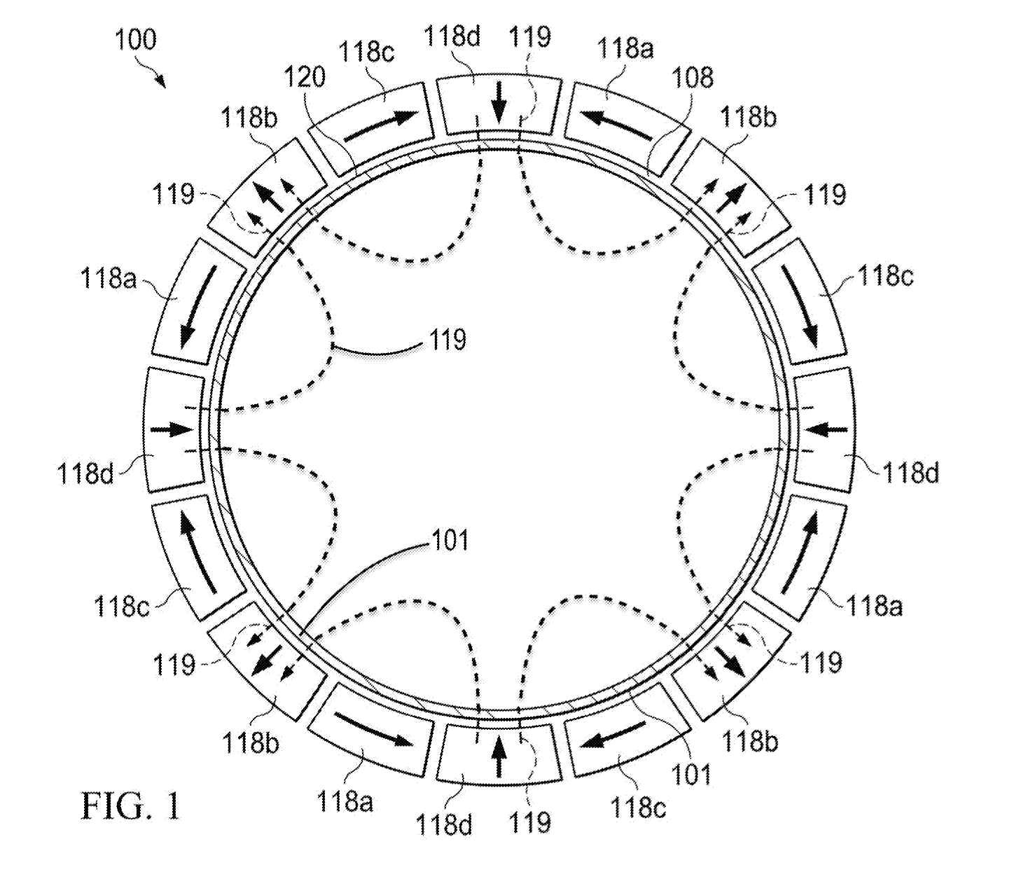

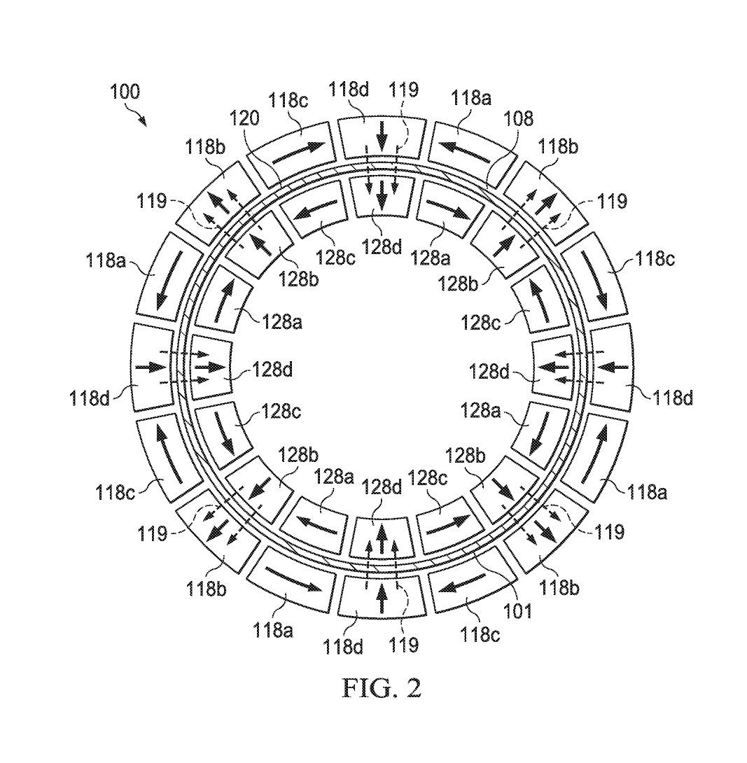

Referring to FIGS. 1-2 of the drawings, the reference numeral 100 generally designates a circular arrangement of magnets, also referred to as “rotors,” embodying features of the present invention. More specifically, the system 100 includes an outer magnet array designated by the reference numeral 118 with a letter appended to it. Magnetic flux lines are designated by numeral 119, which pass through induction cylinder 120. Relative rotation of outer magnet array 118 relative to induction cylinder 120 generates a magnetic force in accordance with Lenz's law, resulting in a transfer of torque between the two. The induction cylinder is fabricated from material having high electrical conductivity, such as carbon nanotubes, copper, or aluminum, for example.

In FIG. 1, illustrated is a schematic of a single rotor embodiment. Outer magnet array 118 embodies a single rotor positioned outside induction cylinder 120. Radial magnets 118b and 118d alternate in magnetic polarity, and are separated by circumferential magnets 118a and 118c, which alternate counterclockwise and clockwise respectively. Magnetic flux lines 119 emanating from rotor 118 pass through induction cylinder 120. When rotor 118 is at rest relative to induction cylinder 120, the magnetic flux lines 119 have no effect, and there is no electromotive force between the rotor and the induction cylinder. Movement of rotor 118 relative to induction cylinder 120 evokes Lenz's Law of induction so that rotation of one induces rotation of the other resulting in transfer of torque between rotor 118 and induction cylinder 120.

In FIG. 2, outer magnet array 118 is magnetically coupled to an inner magnet array designated by the reference number 128 with a letter appended to it. The magnetic coupling occurs at various points around each array as exemplified by magnetic flux lines 119. Magnetic coupling between the inner and outer arrays of magnets 118, 128, results in a transfer of torque between the inner and outer arrays of magnets. Accordingly, when one array 118 or 128 is urged to rotate, the other array also rotates as the arrays are magnetically coupled, as disclosed in the Halbach Motor and Generator, U.S. Pat. No. 9,876,407.

An induction cylinder 120 is interposed between arrays 118 and 128. Induction cylinder 120 is fabricated from an electrically conductive material, such as copper or aluminum. When induction cylinder 120 is at rest relative to the coupled magnet cylinders 118 and 128, no force exists on the induction cylinder 120. Movement of induction cylinder 120 relative to coupled magnet cylinders 118 and 128 generates an electrical current within induction cylinder 120, in accordance with Lenz's law of induction. The electrical current, contained completely within the induction cylinder 120 induces a magnetic field of its own. The induced magnetic field contained within the induction cylinder 120 results in an electromotive force, and torque transfer, between the induction cylinder 120 and the coupled magnet arrays 118 and 128.

The first magnetic rotor 118 and the second magnetic rotor 128 represent an arrangement of magnets alternating N/S polarity, and may be a pair of double-nested coaxial Halbach cylinders, well-known to those skilled in the art. It should be understood, however, that embodiments of the invention are not limited to the Halbach cylinder, and are meant to include any configuration of one or more coaxial magnet arrays that are coupled so as to create magnetic field lines that pass through an induction cylinder fabricated from conducting material.

It should be apparent to one skilled in the art that the function of the magnetic arrays 118 and/or 128 is to generate a magnetic field that produces a force when proximate to an induction cylinder of conducting material as per Lenz's law. Strictly speaking, either the first magnetic rotor 118 or the second magnetic rotor 128 would alone be sufficient to transfer torque to induction cylinder 120 across a small enough gap if the magnetic fields were sufficiently strong. Presence of the induction cylinder 120 between the magnetic arrays 118, 128 increases the torque transfer.

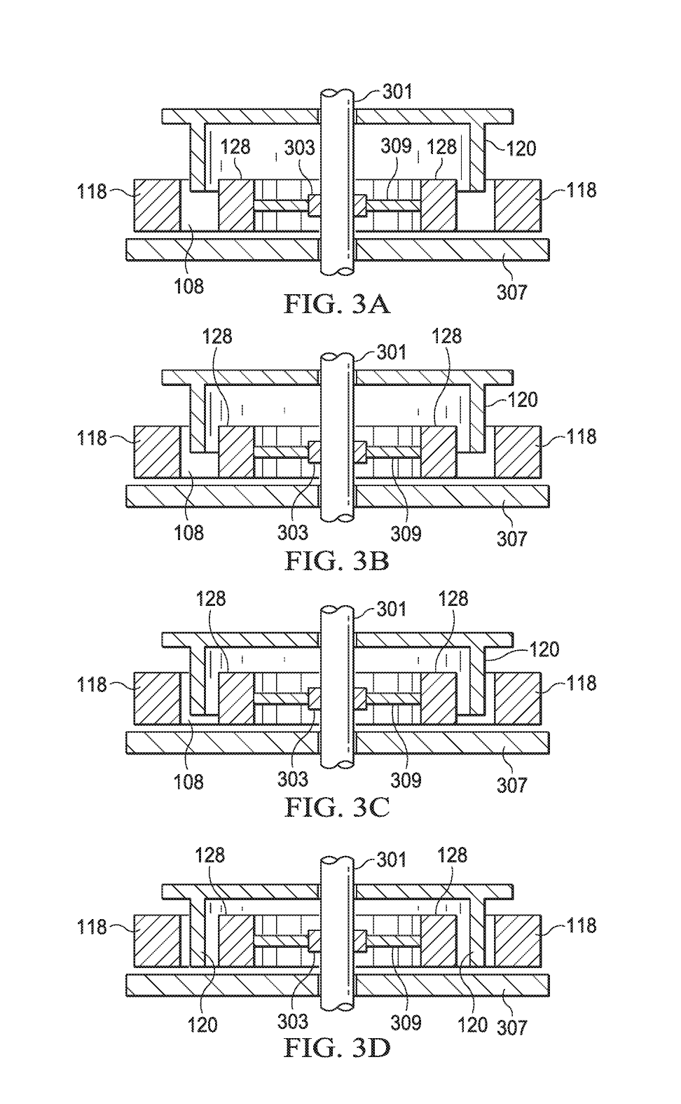

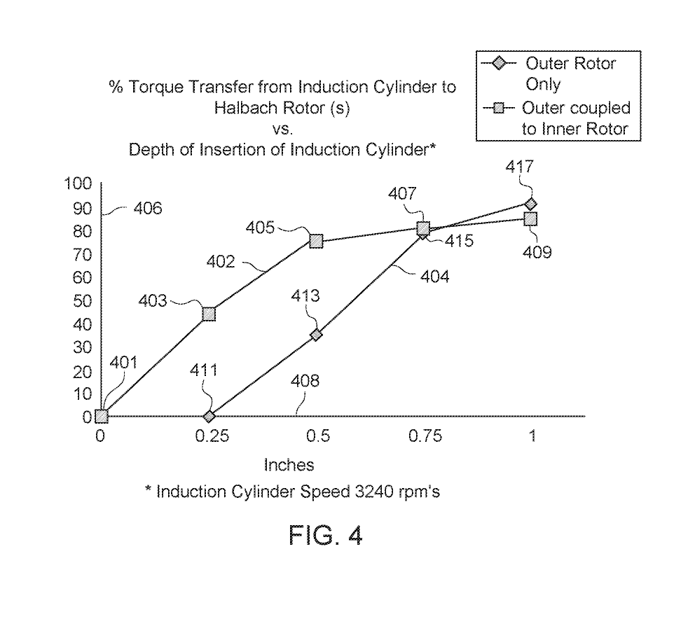

With reference to FIGS. 3A-3D and FIG. 4, experimentation has shown that when the magnet rotors 118 and 128, hereafter the dual rotor magnet assembly or simply the dual rotors, are rotated relative to induction cylinder 120 (e.g., at 3,240 RPM per FIG. 4), torque is transferred between induction cylinder 120 and magnet rotors 118 and 128. The degree of torque transferred depends upon the degree to which induction cylinder 120 is lowered into a gap 108 defined between outer magnet rotor 118 and inner magnet rotor 128. Induction cylinder 120 has a height preferably sufficient to enter the full depth of gap 108, and is attached to rotatable shaft 301.

Reference numeral 402 in FIG. 4 shows the torque transfer curve of the dual rotor magnet assembly of FIGS. 3A-3D coupled to the induction cylinder at various depths of insertion. FIG. 3A shows induction cylinder 120 penetrating gap 108 by 0.25 inches. Referring now to FIG. 4, about 40% of torque from the dual rotors is transferred to induction cylinder 120, as indicated by data point 403. When induction cylinder 120 is lowered in gap 108 to 0.50 inches, as shown in FIG. 3B, the transfer of torque increases to over 70%, as per data point 405 on FIG. 4. When induction cylinder 120 is lowered in gap 108 to 0.75 inches, as shown in FIG. 3C, the transfer of torque increases to over 80% as per data point 407 on FIG. 4. When induction cylinder 120 is lowered in gap 108 to full depth, as shown in FIG. 3D, the transfer of torque increases to over 80% as per data point 409 on FIG. 4.

By way of comparison, reference numeral 404 shows the torque transfer curve when only one rotor, namely outer magnet rotor 118, is rotating relative to induction cylinder 120, as depicted in the schematic FIG. 1. FIG. 4 illustrates that torque transfer begins to occur at a lower depth of insertion in the dual rotor embodiment indicated by reference numeral 402. At a depth of 0.25 inches, for example, the dual rotor embodiment effects over 40% torque transfer as indicated by data point 403. In contrast, data point 411 indicates that at 0.25 inches, zero torque is transferred between the single rotor embodiment and the induction cylinder. At greater depths of insertion, torque is effectively transferred in either case, however, the dual rotor embodiment illustrated in FIGS. 3A-3D has increased amounts of torque transfer at a shallower depth of insertion.

The depth of insertion of induction cylinder 120 into the magnet assembly, which may include either rotor 118, rotor 128, or both, may be controlled by an actuator. Hereafter, the term “actuator” may be interpreted broadly as a component of a machine responsible for moving, or causing to move, another component of the machine. In simple terms, an actuator is a “mover”.

Actuators are well known to those skilled in the art, and may be powered by electricity, hydraulic pressure, hydraulic pressure, or even energy supplied by human power. Upon receipt of an appropriate signal, an actuator converts the signal into mechanical motion. Examples include a solenoid and plunger opening a door lock, a wheel attached to a shaft and piston, a hydraulic brake cylinder, and a gear shifter attached via a cable to derailleur gears. A broad spectrum of actuators may be configured for operational attachment to induction cylinder 120 and successful control of the depth of insertion of the induction cylinder into the magnet assembly, resulting in controlled variable torque transfer.

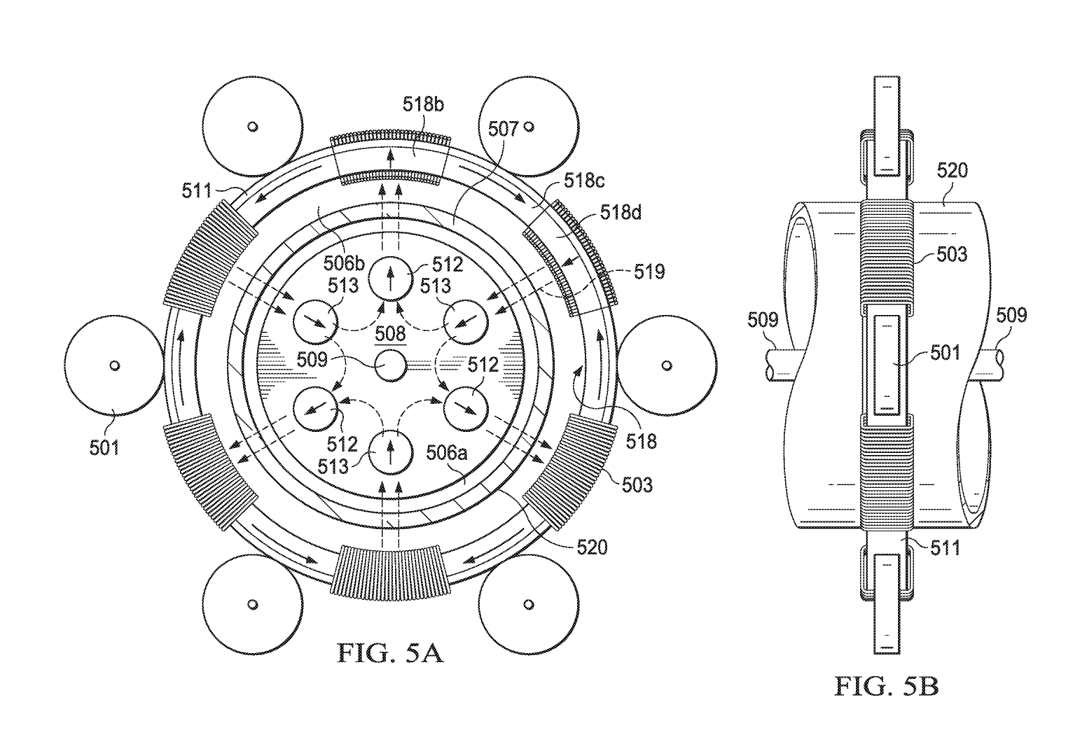

FIG. 5A illustrates an alternate embodiment in which an outer magnet rotor 518 includes a Halbach cylinder that is magnetically coupled to an inner rotor assembly 508 including alternating magnets 512 and 513. This configuration generates periodic and alternating magnetic flux lines 519, which are nodes of high magnetic flux density. Magnetic flux lines 519 pass through induction cylinder 520. This embodiment demonstrates that magnetic coupling and torque transfer may occur between a variety of coaxial magnetic arrays, and that cylinders need not be configured as Halbach cylinders. Although the magnets 512 and 513 within inner rotor assembly 508 alternate in polarity, this alternation is not absolutely necessary. Any configuration of magnets within the inner or outer rotor that results in magnetic flux passing through the induction cylinder 520 will function to some degree in accordance with Lenz's law of induction.

Outer magnet rotor 518 is surrounded by a number of outer rotor supports 511 which provide structural support to magnet rotor 518. Outer rotor support 511 also provides a bearing surface for wheel bearings 501, which serve to center outer magnet rotor 518 as it rotates with a number of energizing coils designated 503. Energizing coils 503 urge rotation of outer magnet rotor 518, which is coupled to inner rotor assembly 508, which rotates about shaft 509. Torque is thereby transferred from outer magnet rotor 518 to inner rotor assembly 508 across flux lines 519, which pass through induction cylinder 520.

The embodiment of FIGS. 5A and 5B thus illustrates two possible modes of torque transfer from outer magnet rotor 518. Direct or primary torque transfer occurs as a result of the magnetic coupling between outer magnet rotor 518 and inner rotor assembly 508. This torque is transferred directly to drive shaft 509. Secondary torque transfer may also occur simultaneously as a result of the induced electromotive forces resulting from the effect of magnetic field lines 519 upon induction cylinder 520 in accordance with Lenz's law of induction. Both modes of torque may occur within the same motor/generator configuration.

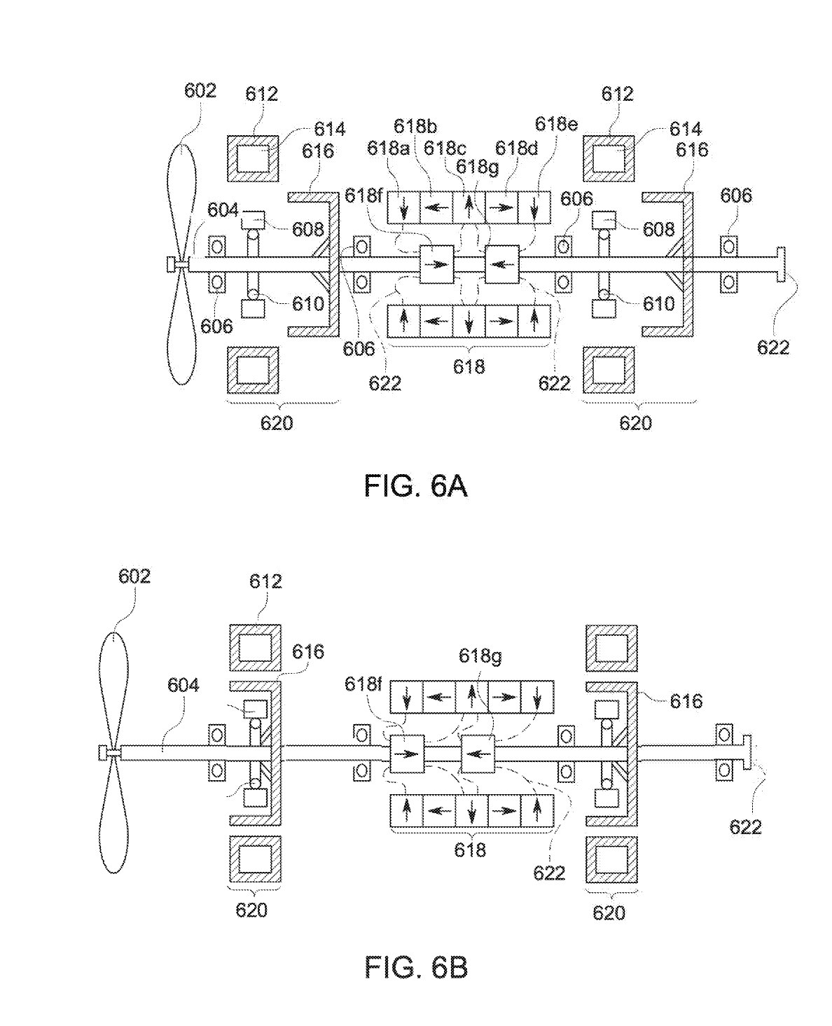

FIGS. 6A-6B demonstrate a cross-sectional schematic view of two induction drives 620 attached to a common shaft 604 linked to a passive magnetic bearing 618. This embodiment allows torque matching between toroid motor/generator 612 and propeller 602 across a spectrum of rotational rates. Further configuring the propeller with a variable pitch assembly assures the powertrain always operates at peak torque transfer efficiency regardless of propeller pitch and rotational rate.

FIG. 6A shows induction cylinder 616 fixedly attached to shaft 604, and positioned outside a dual rotor magnet assembly. Inner or secondary rotor 608 is magnetically coupled to outer or first magnetic rotor 614. Inner rotor 608 rotates about shaft 604 with the aid of bearing 610. This dual rotor magnet assembly is incorporated within a toroid motor that includes stator 612. Shaft 604 freely rotates within a series of bearings labeled 606, and is attached to propeller 602.

Energizing the stator 612 causes a rotation of first magnetic rotor 614, which is magnetically coupled to inner rotor 608, which also begins to rotate. This causes rotation of induction cylinder 616 in accordance with Lenz's Law, further resulting in rotation of shaft 604 attached to propeller 602. Propeller rotation results in an axial force on shaft 604 which displaces shaft 604 to the left in this schematic. This axial displacement is allowed only to a limited degree by passive magnetic bearing 618. Circular magnets 618f and 618g are fixedly attached to shaft 604, and are magnetically coupled to the magnet array made of magnets 618a-e.

The degree to which shaft 604 is displaced to left is limited by reluctance magnet forces between circular shaft magnets 618f-g and magnet arrays 618a-e. Increasing thrust produced by propeller 602 results in increasing leftward displacement of shaft 604 to the point that induction cylinder 616 is fully engaged between rotors 614 and 608 in FIG. 6B. This state of full engagement allows for maximum torque transfer between the toroid motor and the propeller. Including an optional variable pitch device for the propeller may enhance energy efficiency across a spectrum of thrust requirements.

FIG. 6A-B also serve to demonstrated optimal functioning of electric power generation in an embodiment configured as a wind turbine. A light wind flowing from right to left across propeller blade 602 results in rotation of the propeller as well as leftward displacement of the propeller shaft 604, and a limited engagement of induction cylinder 616 within motor/generator 612, thus generating a smaller amount of electricity. Increased wind speed results in further leftward displacement, albeit limited by passive magnetic bearing 618. This displacement further engages induction cylinder 616 within motor/generator 612, thus generating more electricity. Further engagement within the generator also results in increased resistance to rotation of propeller shaft 604 attached to propeller 602. The result is that increased torque from increased wind not only increased propeller speed but also generates more electricity. Configuring propeller 602 with a variable pitch device ensures optimal torque across a spectrum of wind speeds, and thus optimal energy generation. To be sure, a variable pitch device is completely optional.

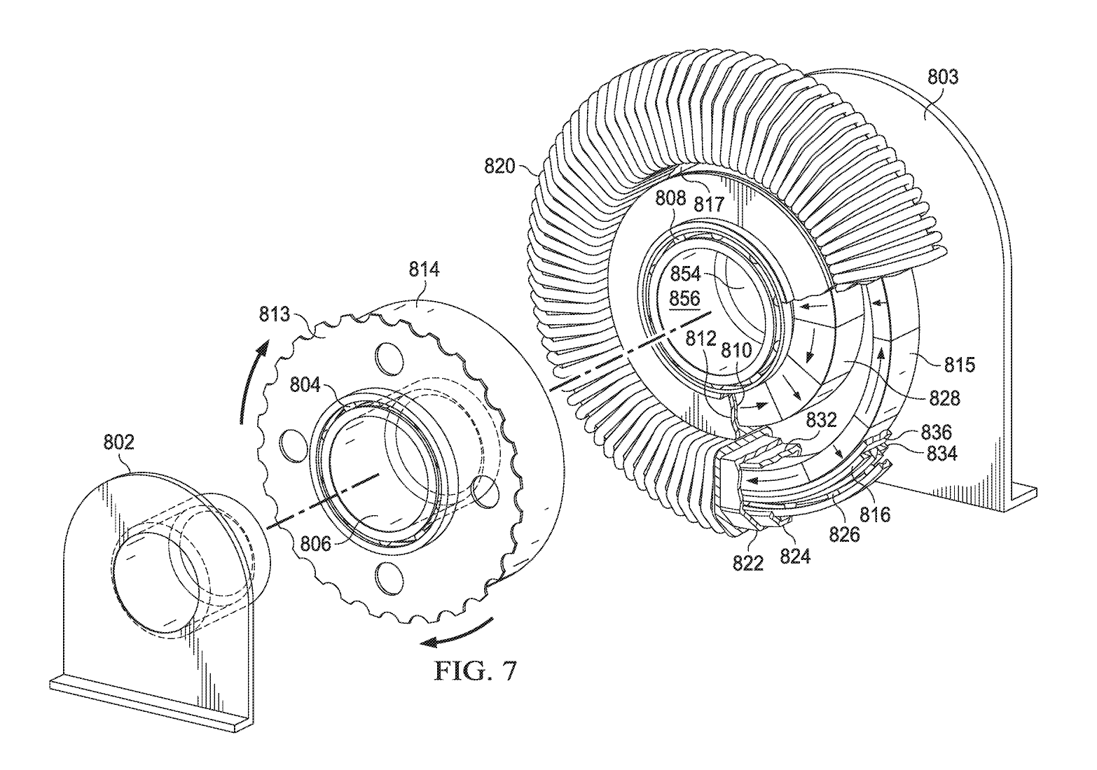

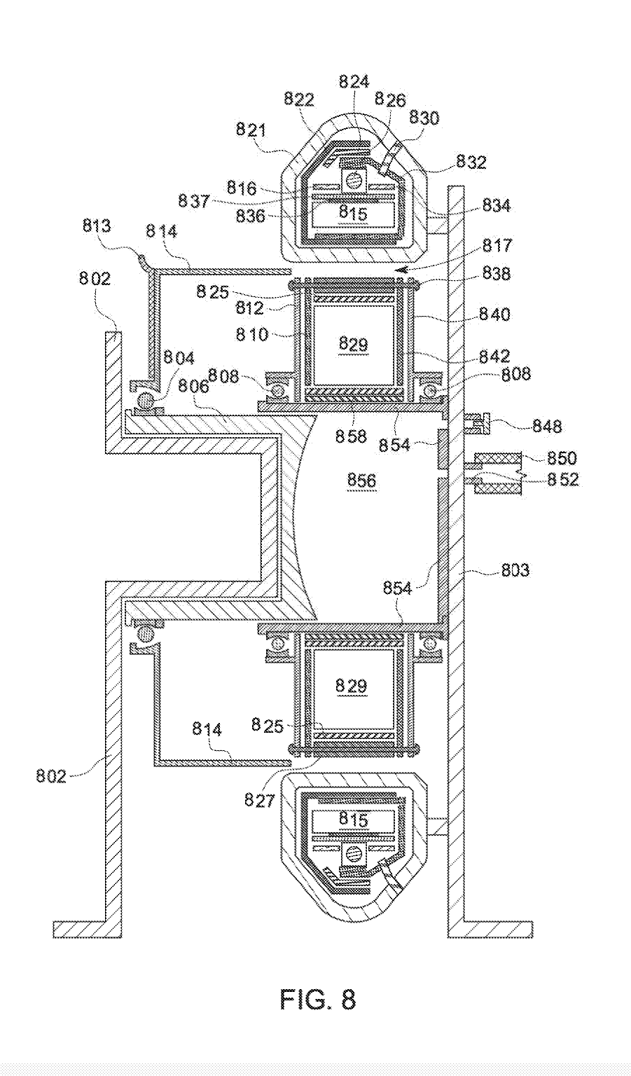

FIGS. 7-8 represent illustrate a compact embodiment that includes a dual rotor toroid motor configured for a variable magnetic reduction drive. FIG. 7 is the exploded view while FIG. 8 represents the cross-sectional view of FIG. 7.

Motor/generator stator 821 surrounds first magnetic rotor 818 magnetically coupled to inner rotor 829 positioned so as to include a gap 817 into which may be received induction cylinder 814. Sprocket 813 is attached to cylinder 814 for mechanical power transfer via a chain, although any mechanical transfer system may be employed such as a pulley for a belt or a gear for a worm drive. Induction cylinder 814 is fabricated from electrically conducting material such as copper, and freely rotates around bearing 804 attached to hydraulic cylinder 806. Hydraulic fluid entering through pressure line 850 through port 852 into hydraulic cylinder housing 854 surrounding chamber 856. Influx of hydraulic fluid causes hydraulic cylinder 806 to slide leftward from hydraulic cylinder housing 854 so as to be received slidably by frame 802. Bleeder valve 848 allows bleeding contaminants from chamber 856 when necessary.

Inner rotor frame 812 attaches to bearing 808, thus allowing free rotation of inner rotor 829 encased in dampening sheet 810 and dampening cylinders 825, which may be fabricated of non-magnetic material such as fiberglass. The purpose of the dampening elements is to absorb vibration during operation when brittle rare earth magnets are employed. Flux element 827 channels magnetic flux emanating from magnet poles within inner rotor 829 so as to align with magnet poles emanating from first magnetic rotor 818. Flux element 827 is fabricated from ferromagnetic material, and is attached to frame 812 by bolt 838, thus also serving a structural purpose in retaining inner rotor 829 during operation.

First magnetic rotor 818 is attached to thin section bearing 826 by a spring steel band 836 attached to carbon fiber ring 837. Bearing 826 is further attached to fiberglass half shell inner element 822 and outer element 832 separated by dampener 824 made of fiberglass and silicon. Positioning rings 816 hold bearing 826 in place. This configuration allows for free rotation of outer bearing 818 within stator 821.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A variable magnetic torque transfer device, comprising:
a magnetic rotor including a plurality of individual magnets positioned on the rotor such that adjacent magnets alternate in magnetic orientation;
an induction cylinder coaxial with the magnetic rotor and having a circumference smaller than an internal circumference of the magnetic rotor, or larger than an external circumference of the magnetic rotor, the induction cylinder disposed adjacent the magnetic rotor and positioned for relative rotation through magnetic flux lines emanating from the magnetic rotor.

2. The variable magnetic torque transfer device according to claim 1, further comprising an actuator configured to move the induction cylinder relative to the magnetic rotor.

3. The variable magnetic torque transfer device according to claim 1, in which the induction cylinder is coupled to a means of mechanical torque transfer that has an axis of rotation through the center of the magnetic rotor.

4. The variable magnetic torque transfer device according to claim 1, in which the induction cylinder is a metal cylinder.

5. The variable magnetic torque transfer device according to claim 1 in which the magnetic rotor is a first magnetic rotor, and further comprising a second magnetic rotor positioned coaxially to the first magnetic rotor in a magnetically coupled relationship with the first magnetic rotor, the second magnetic rotor including a second plurality of magnets positioned on the second magnetic rotor such that adjacent magnets alternate in magnetic orientation.

6. The variable magnetic torque transfer device according to claim 5 in which the induction cylinder is variably disposed within a gap that exists between the first magnetic rotor and the second magnetic rotor.

7. A variable magnetic torque transfer device, comprising:
a first magnetic rotor including a first plurality of individual magnets positioned such that adjacent magnets alternate in magnetic orientation;
a second magnetic rotor magnetically coupled to the first magnetic rotor and coaxial with the first magnetic rotor, the second magnetic rotor including a second plurality of magnets positioned such that adjacent magnets alternate in magnetic orientation, the second magnetic rotor having a circumference smaller than an internal circumference of the first magnetic rotor, so that a cylindrical gap exists between the first magnetic rotor and the second magnetic rotor; and
an induction cylinder coaxial with the first magnetic rotor and having a diameter that approximates a diameter of the cylindrical gap, the induction cylinder disposed at least partially within the gap and positioned for relative rotation through magnetic flux lines passing between the first magnetic rotor and the second magnetic rotor.

8. The variable magnetic torque transfer device according to claim 7 further comprising a stator having a plurality of electric coils arranged in the shape of a toroid and configured for rotation of the first magnetic rotor within the stator, the stator structured to urge rotation of the first magnetic rotor when controlled current is applied through the electric coils of the stator.

9. The variable magnetic torque transfer device according to claim 7 further including:
a propeller shaft attached to the induction cylinder;
a propeller attached to the propeller shaft; and
a passive magnetic thrust bearing coupled to the propeller shaft in which an axial force on the propeller shaft urges the induction cylinder deeper within the gap.

10. The variable magnetic torque transfer device according to claim 7 further comprising an actuator configured to control the movement of the induction cylinder within the gap.

11. The variable magnetic torque transfer device according to claim 10 wherein the actuator is positioned inside the second magnet rotor.

12. The variable magnetic torque transfer device according to claim 7 wherein the induction cylinder further comprises a mechanic means of torque transfer.

13. A method of torque transfer from a driving shaft to a driven shaft, the driving shaft fixedly coupled to a magnetic rotor including a first plurality of individual magnets coupled to the rotor and having alternating orientations, the method comprising:
positioning an induction cylinder that is coupled to the driven shaft and having a circumference slightly smaller than an internal circumference of the magnetic rotor, or slightly larger than an external circumference of the magnetic rotor to a location adjacent the magnetic rotor and causing magnetic flux from the magnetic rotor to pass through the induction cylinder.

14. The method of torque transfer according to claim 13, in which positioning an induction cylinder comprises controlling an actuator to variably position the induction cylinder.

15. The method of torque transfer according to claim 13, in which positioning an induction cylinder comprises controllably allowing a shaft coupled to the induction to move relative to the magnetic rotor.

16. A method for transferring torque, the method comprising steps of:
magnetically coupling a first magnetic rotor to a second magnetic rotor so that lines of magnetic flux between the coupled cylinders alternate in magnetic polarity;
positioning the first magnetic rotor and the second magnetic rotor so that a cylindrical gap exists between the rotors;
positioning an induction cylinder for relative rotation within the cylindrical gap;
rotating the metal cylinder relative to the coupled rotors; and
magnetically coupling the first and second magnetic rotors with the induction cylinder.

17. The method for transferring torque according to claim 16, further comprising:
operating an actuator that is coupled to the induction cylinder to control insertion of the induction cylinder into the cylindrical gap.
